(19) United States
(12) Patent Application Publication
(10) Pub. No.: US 2012/0303535 A1
(43) Pub. Date: Nov. 29, 2012

(54) SYSTEMS AND PROCESSES FOR AGREEMENT MANGEMENT

(76) Inventor: Frederick E. Guest, III, Las Vegas, NV (US)

(21) Appl. No.: 13/236,500

(22) Filed: Sep. 19, 2011

Related U.S. Application Data
(60) Provisional application No. 61/489,897, filed on May 25, 2011.

(51) Int. Cl. G06Q 20/00; G06Q 30/00; G06Q 40/00

(52) U.S. Cl. 705/80; 705/35; 705/14.1

(57) ABSTRACT

A process and system of managing agreements among users is provided. A proposed agreement is received from a first user. The proposal is relayed to a second user to view and to choose whether to accept the proposal. The agreement specifies that, at a particular time, if a particular condition is met, one user will owe the other a payment. At the specified time, a user is asked whether the condition has been met. If it has, one user will owe the other the payment.

### CROSS-REFERENCE TO RELATED PATENT APPLICATIONS

This application claims priority from Provisional Application U.S. Application 61/148,897, filed May 25, 2011, incorporated herein by reference in its entirety.

### BACKGROUND

1. Field of the Invention

Embodiments of the present invention relate generally to systems and processes for managing contractual agreements.

### SUMMARY OF THE DISCLOSURE

Various embodiments of the present invention provide a computer-implemented process or system for managing a contractual agreement. According to example embodiments, a computer accepts a submission of information about an agreement from one or more submitting users. The agreement specifies that, if a particular condition is true, for example, at or within a specified time, then a payment will be made from one or more paying users. The information about the agreement is stored by the processor on non-transient storage media of the computer. At the specified time, using a processor of the computer, one or more selected users are asked for their input regarding whether the particular condition is true.

In some embodiments of the present invention, the process or system is implemented by at least one device communicating directly with another device through a peer-to-peer network.

In some embodiments of the present invention, the agreement specifies that, if the particular condition is not true, an alternate payment will be made from one or more alternate paying users.

In some embodiments of the present invention, the agreement specifies that the information, input, and requests are communicated between user computers or between user computers and a system computer, across a computer network.

In some embodiments of the present invention, accepting a submission of an agreement involves accepting first a proposal for the agreement from the one or more submitting users and second an acceptance of that proposal from one or more accepting users.

In some embodiments of the present invention, if input from the one or more selected users indicates that the particular condition is true, then a processor of the computer requests that the one or more paying users make their payment(s). In further embodiments of the present invention, a processor of the computer requests that the one or more paying users make the payment by purchasing one or more offers in lieu of the payment. In some embodiments of the present invention, if the one or more paying users agrees to purchase the one or more offers, a gift card, coupon, or other certificate of value is offered to at least one receiving user in lieu of at least part of a payment due to the at least one receiving user.

In some embodiments of the present invention at least one suggested arbiter may be selected or accepted from at least one suggesting user. Then, input from the at least one arbiter is accepted regarding whether the particular condition is true. Whether the at least one paying user owes the payment is determined by whether the arbiter indicates that the particular condition is true, using a processor of the computer. In alternate embodiments of the present invention, one arbiter is selected, from a group of one or more arbiters suggested by the at least one suggesting user. In further embodiments, if no arbiter was suggested by at least two suggesting users, then the suggesting users are requested to suggest arbiters again. In some embodiments, ranks of the suggested arbiters are accepted from users, and the one arbiter is selected based on the ranking.

### BRIEF DESCRIPTION OF THE DRAWINGS

FIG. 1 is a schematic diagram of a system in accordance with an embodiment of the present invention;

FIG. 2 illustrates a computer system for implementing a method of modifying data in accordance with the present invention;

FIG. 3 is a flow diagram of a process according to an embodiment of the present invention, wherein two users participate in a managed agreement;

FIG. 4 is a generalized view of a communication device that is configured to manage an agreement, including requesting that the user give the user name of a second user to be involved in the agreement, according to an embodiment of the present invention;

FIG. 5 is a generalized view of a communication device that is configured to begin a managed agreement, including a display screen for displaying the potential outcomes involved in the agreement, as input by a user, according to an embodiment of the present invention;

FIG. 6 is a generalized view of a communication device that is configured to conclude a managed agreement, including a display screen for displaying the potential outcomes involved in the transaction, so that the user may select the one that occurred, according to an embodiment of the present invention;

FIG. 7 is a generalized view of a communication device that is configured to conclude a managed agreement, including a display screen for displaying the amount owed as a result of the agreement, so that the user may accept or dispute it, according to an embodiment of the present invention;

FIG. 8 is a flow diagram of a process according to an embodiment of the present invention, wherein two users conclude a managed agreement by determining whether to reconcile the amount owed using a gift card;

FIG. 9 is a generalized view of a communication device that is configured to conclude a managed agreement, including a display screen for offering as an option that the payer make the payment using a gift card, according to an embodiment of the present invention;

FIG. 10 is a generalized view of a communication device that is configured to conclude a managed agreement, including a display screen for offering as an option that the payee accept payment by accepting a gift card, according to an embodiment of the present invention;

FIG. 11 is a flow diagram of a process according to an embodiment of the present invention, wherein the users conclude a managed agreement through arbitration in the event of a disagreement;

FIG. 12 is a generalized view of a communication device that is configured to conclude a managed agreement through arbitration in the event of a disagreement, including a display screen for requesting that the user input the user names of potential arbiters, according to an embodiment of the present invention; and

FIG. 13 is a generalized view of a communication device that is configured to conclude a managed agreement through arbitration in the event of a disagreement, including a display screen for requesting that arbiter select an outcome in order to resolve a dispute between users, according to an embodiment of the present invention.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the present disclosure.

Embodiments of the present invention may be implemented in a computer network environment, in which a service operates one or more service computers (or servers) that are connected for communication over an electronic communications network with two or more users operating user computers. (Alternatively, in some embodiments, there is just one user.) According to various embodiments of the present invention, the service entity includes an agreement management service that oversees agreements among users. Users register for or otherwise access a service. A first user or group of users submits a proposal for an agreement to the service. The service receives it and relays it to a second user or group of users. This second group may make one or more counter-proposals if they wish. Or, they may agree to the first proposal. If a counter-proposal is made by the second group, then the first group can either accept a counter-proposal or make another one or more proposals. This process may continue for as long as the users desire or until a proposal is agreed upon. Once the parties agree to a proposal, the service accepts their agreement. The service then stores information about their agreement in non-transient memory.

The agreement includes that, at or within a specified time, if a specified condition is met (such as, but not limited to, that an event has occurred), one user (or group) will owe another user (or group) a payment. According to various embodiments, the service keeps track of when the specified time has arrived (or that the specified condition was met, if met before the specified time) and alerts the appropriate users to that fact. According to other embodiments, a user (or group) keeps track of the specified time (or keeps track of the condition) and notifies the service that the time has arrived, has already arrived, or will arrive (or that the condition has been met). Then, the service accepts input from one or more users regarding whether the condition has been met. If it has, the service will determine that one or more users will owe payment(s). According to some embodiments, the service will request that the users who owe make their payment. According to other embodiments, the service will automatically deduct payment from the account(s) of the user(s) who owe.

According to some embodiments, the agreement management service is implemented as a peer-to-peer service. In such a system, a first peer (user device) submits to one or more peers (user devices) a proposal for an agreement. (These are referred to as the “first device” and the “second device,” respectively, for simplicity.) A second device receives the submission. The second device submits to the first device an acceptance of the proposal or a decline. The second device may additionally submit its own counter-proposal. Once a proposal is accepted, the devices store information regarding the accepted agreement. One or more devices notify their respective users when the specified time arrives, when it has already arrived, or before it arrives (or that the condition has been met). According to some embodiments, the device that submitted the proposal is the device that performs this notification. One or more devices query their respective users regarding whether the condition specified in the agreement is true. According to some embodiments, the device that created the proposal is the device that gives the query regarding whether the condition specified in the agreement is true. The querying device then accepts input from its user(s) regarding whether the specified condition is true. According to some embodiments, one or more devices will automatically deduct payment from the account(s) of their respective user(s) who owe.

Various embodiments include hardware devices, as well as program products comprising computer-readable, non-transient storage media for carrying or having data or data structures stored thereon for carrying out processes as described herein. Such non-transient media can be any available media that can be accessed by a general purpose or special purpose computer or server. By way of example, such non-transient storage media can comprise random-access memory (RAM), read-only memory (ROM), erasable programmable read-only memory (EPROM), electrically erasable programmable read-only memory (EEPROM), field programmable gate array (FPGA), flash memory, compact disk, or other optical disk storage, magnetic disk storage or other magnetic storage devices, or any other medium which can be used to carry or store desired program code in the form of computer-executable instructions or data structures and which can be accessed by a general purpose or special purpose computer. Combinations of the above are also to be included within the scope of non-transient media. Volatile computer memory, non-volatile computer memory, and combinations of volatile and non-volatile computer memory are also to be included within the scope of non-transient storage media. Computer-executable instructions comprise, for example, instructions and data that cause a general-purpose computer, special purpose computer, or special purpose processing device to perform a certain function or group of functions.

In addition to a system, various embodiments are described in the general context of methods and/or processes, which is implemented in some embodiments by a program product including computer-executable instructions, such as program code, executed by computers in networked environments. The terms “method” and “process” are synonymous unless otherwise noted. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

In some embodiments, the method(s) and/or system(s) discussed throughout are operated in a networked environment using logical connections to one or more remote computers having processors. In some embodiments, logical connections include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like.

In some embodiments, the method(s) and/or system(s) discussed throughout are operated in distributed computing environments in which tasks are performed by local and remote processing devices that are linked (either by hardwired links, wireless links, or by a combination of hardwired or wireless links) through a communications network. In a distributed computing environment, according to some embodiments, program modules are located in both local and remote memory storage devices. In various embodiments, data are stored either in repositories and synchronized with a central warehouse optimized for queries and/or for reporting, or stored centrally in a database (e.g., dual use database) and/or the like.

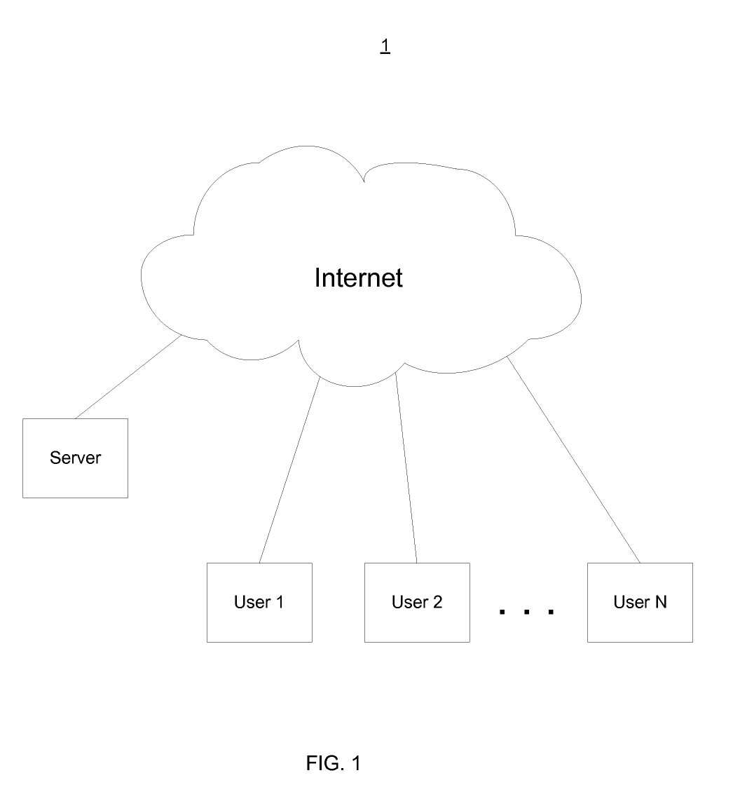

FIG. 1 illustrates a non-limiting system according to some embodiments of the present invention. As shown in FIG. 1, an exemplary networked system 1 for implementing process(es) according to embodiments of the present invention includes, but is not limited to, a general-purpose computing device that interacts with users through a communications network, such as, but not limited to, the Internet. According to some embodiments, the computing device is a server that communicates over the network with user devices, which include, but are not limited to, general-purpose computers, smartphones, PDAs, and the like. According to some embodiments, user devices communicate with a server through a website. According to some of those embodiments, the user devices are mobile devices and the website is a mobile website, intended to be accessed through mobile devices. The user devices communicate with a server or with each other through one or more applications comprising computer-executable instructions.

Although the exemplary system 1 of FIG. 1 involves communication through the Internet, other embodiments may include one or more servers interacting with users through any type of network. Other embodiments may involve peer-to-peer communication between user devices rather than between user devices and a server. Alternate embodiments may not involve a network at all, and may instead be implemented on a standalone device used by the user(s).

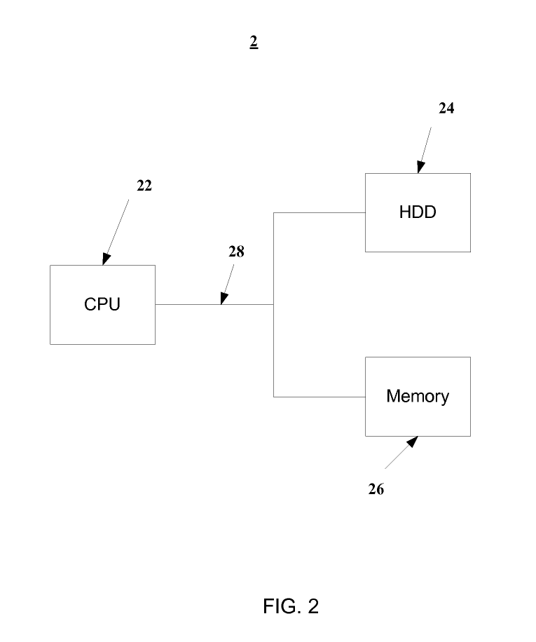

FIG. 2 illustrates a non-limiting system according to some embodiments of the present invention. As shown in FIG. 2, an exemplary system 2 for implementing the method(s) discussed include (but is not limited to) a general-purpose computing device in the form of a conventional computer, including a processing unit 22 or processor, a system memory 26, and a system bus 28 that couples various system components including the system memory 26 to the processing unit 22. The system memory 26 includes one or more suitable memory devices such as, but not limited to, RAM. The computer includes a storage medium 24, such as, but not limited to, a solid state storage device and/or a magnetic hard disk drive (HDD) for reading from and writing to a magnetic hard disk, a magnetic disk drive for reading from or writing to a removable magnetic disk, and an optical disk drive for reading from or writing to removable optical disk such as a CD-RW or other optical media, flash memory, etc. The drives and their associated computer-readable media provides non-transient, non-volatile storage of computer-executable instructions, data structures, program modules, and other data for the computer to function in the manner described herein. Various embodiments employing software and/or Web implementations are accomplished with standard programming techniques.

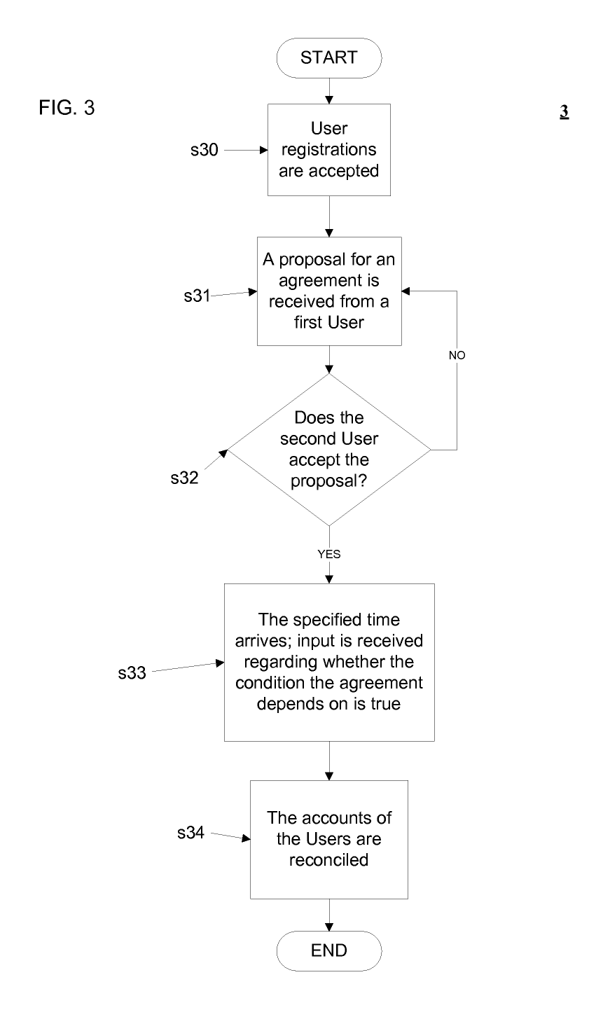

With reference to FIG. 3, according to various embodiments, the agreement management service is implemented by the computer system 2 according to a process as shown in FIG. 3. First, in step s30, the service accepts registrations for the service from users that have not registered already. However, according to other embodiments, no registration is necessary. For example, individual users each register for a different user account, or groups of users can share the same user account. According to various embodiments, registering for the service includes creating a unique user name and a password associated with a user account. In further embodiments, step s30 additionally includes associating the user account with one or more bank accounts, credit card accounts, money transfer service accounts, reward accounts such as those that provide points that can be exchanged for goods or services, or other accounts that can provide a benefit, financial or otherwise. In yet further embodiments, step s30 additionally includes associating the user account with an email address, postal address, phone number, and/or other identifier so that the service may communicate with the user. According to some embodiments, step s30 additionally includes associating the user account with one or more social networking accounts.

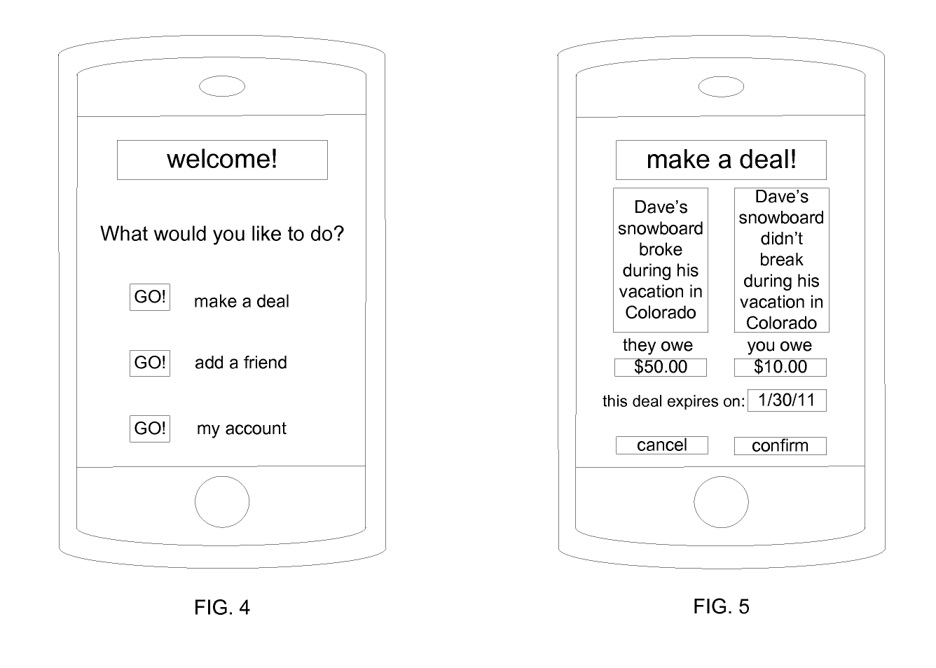

FIG. 4 shows a sample device, according to an embodiment, executing agreement management software which displays a menu of optional actions to a user. This menu is displayed after registration (if applicable). One option is to “make a deal,” or, in other words, to create an agreement between at least one user and optionally other users. According to some embodiments, the other users are not required to have user accounts with the agreement management service. The step of making the deal is discussed further in step s31.

Returning to FIG. 3, in step s31, the agreement management service receives from a user or group of users a proposal for an agreement. For example, all of the agreement is submitted by users and received by the service at once, or, alternatively, portions of the agreement proposal can be submitted at different times, by the same or different users.

According to some embodiments, information about the agreement is stored by the service on non-transient media. In alternative embodiments, information about the agreement is not stored by the service, but transmitted directly or indirectly between users. Information about the agreement is stored on at least one of a server and one or more client devices.

According to some embodiments, information about the agreement is received from the user or users in encrypted form. In some embodiments, the encrypted agreement information is stored by the service in encrypted form. In further embodiments, the encrypted agreement information will not be decrypted until and unless it is presented to a user that is a party to the agreement, an arbiter who is resolving a dispute related to the agreement, or another authorized party. According to some embodiments, the agreement management service does not store decryption information such as encryption keys, so that the service is unable to decrypt the agreement information without a user or other software supplying the decryption information.

This agreement includes at least one condition on which the deal contained in the agreement will depend, and a time that the deal will “expire.” If the condition is true at the time the deal expires, then according to some embodiments, one party will owe a payment, confer a benefit, or the like, according to the terms of the agreement. The condition can be based on whether an event occurs, or is based on the state of something or someone at a specified time, or the like.

According to various embodiments, the agreement is that one party will pay another an amount by a specified time. One non-limiting, exemplary agreement has to do with two roommates, Donna and Susan, who wish to split the cost for a purchase of a chair. Susan does not have the money available at the time of purchase. In order to make sure that Susan will pay what she owes, and to simplify collection of funds, Donna and Susan use the agreement management service. Their agreement is that before July 30th, Susan will pay Donna $50, or else the service will deduct a sum of money from Susan's account. In this case, the condition on which the agreement depends is whether Susan pays Donna $50. The time that the deal will expire is July 30.

According to various embodiments, the agreement may be that one party will pay another an amount, but only if a specified condition is true. Regarding another non-limiting, exemplary agreement, Donna lends Susan some sunglasses for a trip, but is afraid that Susan might lose or break them. Donna and Susan submit an agreement to the agreement management service that if Susan does not return the sunglasses by August 10th, Susan will pay Donna $100. If Susan returns the sunglasses unbroken, neither party owes the other any money. In this case, the condition on which the agreement depends is whether the sunglasses are returned unbroken. The time that the deal will expire is August 10th.

According to various embodiments, the agreement may be that a first party may owe a second party a specified amount, or the second party may owe the first party, depending on whether a specified condition is true. A non-limiting, exemplary agreement has to do with two roommates, Dave and Steve, who wish to split their monthly cable bill, but in any given month, they do not know who (of the two) will be the one who sends in the payment. Dave and Steve submit an agreement to the agreement management service that if Dave pays the cable bill that month, Steve will owe Dave $50 for half of the bill. If Steve pays the cable bill that month, Dave will owe Steve $50 for half of the bill. The bill is due September 1st. In this case, the condition on which the agreement depends is whether Dave paid the bill that month (or, alternatively, whether Steve paid the bill that month). The time that the deal will expire is September 1st.

According to various embodiments, the agreement may be that a first party may owe a second party a specified amount, or the second party may owe the first party a different amount, depending on whether a specified condition is true. Regarding a non-limiting exemplary agreement, Dave is going on a snowboarding trip and is worried that he might break his snowboard. Steve is willing to insure Dave's snowboard in exchange for a payment. Dave will be home from his snowboarding trip by January 30th. Dave and Steve submit an agreement to the agreement management service that if Dave's snowboard breaks, Steve will pay Dave $50, and if it does not break, Dave will pay Steve $10. The condition on which the agreement depends is whether Dave's snowboard breaks during the snowboarding trip. The time that the deal will expire is January 30th.

FIG. 5 shows a sample device executing agreement management software which, according to some non-limiting, exemplary embodiments, displays to the user, Dave, a confirmation page for the deal Dave is proposing to Steve, as it is described in the snowboarding example above. In some embodiments, a confirmation page is displayed to the user or group of users submitting a proposal for an agreement. The proposal may then be submitted or cancelled, according to input from the user(s).

Returning to FIG. 3, in step s32, the agreement management service accepts input from one or more users or groups of users regarding whether the proposed agreement of step s31 is accepted. In some embodiments, if the proposed agreement is not accepted, then the system 3 repeats step s31, requesting a proposed agreement. In that case, the users may submit a new agreement or try again to obtain acceptance of the same proposed agreement. In other embodiments, if the proposed agreement is not accepted, then there is no agreement and the process ends there. According to some embodiments, a confirmation page may be displayed to the user or group of users accepting a proposal for an agreement. For the snowboarding example above, for instance, a confirmation page similar to FIG. 5 (except targeting Steve instead of Dave) may be displayed to Steve, who may then accept or decline the proposal through the confirmation page.

After a proposed agreement is accepted, then in step s33 of FIG. 3, according to some embodiments, the agreement management service waits for the expiration date of the deal to arrive. In some embodiments, the service does not wait until the expiration date if it receives input from a user regarding the agreement, for example, to cancel the agreement or that the condition on which the agreement is based has been fulfilled ahead of the expiration date.

Once the specified time arrives, according to various embodiments, input is received from one or more users or groups of users regarding whether the condition the agreement depends on is true (in other words, indicates the outcome). For example, the agreement management service requests that one or more users provide input or, alternatively, the system waits for one or more users to volunteer input and does not request it. In some embodiments, the user (or users) who proposed the agreement is the user (or users) who indicates the outcome, or the user (or users) who accepted the agreement proposed by someone else is the user (or users) who indicates the outcome, or alternatively, any of the users who are parties to the agreement indicate the outcome, or in yet another alternative, anyone, not just those who are parties to the agreement, indicates the outcome.

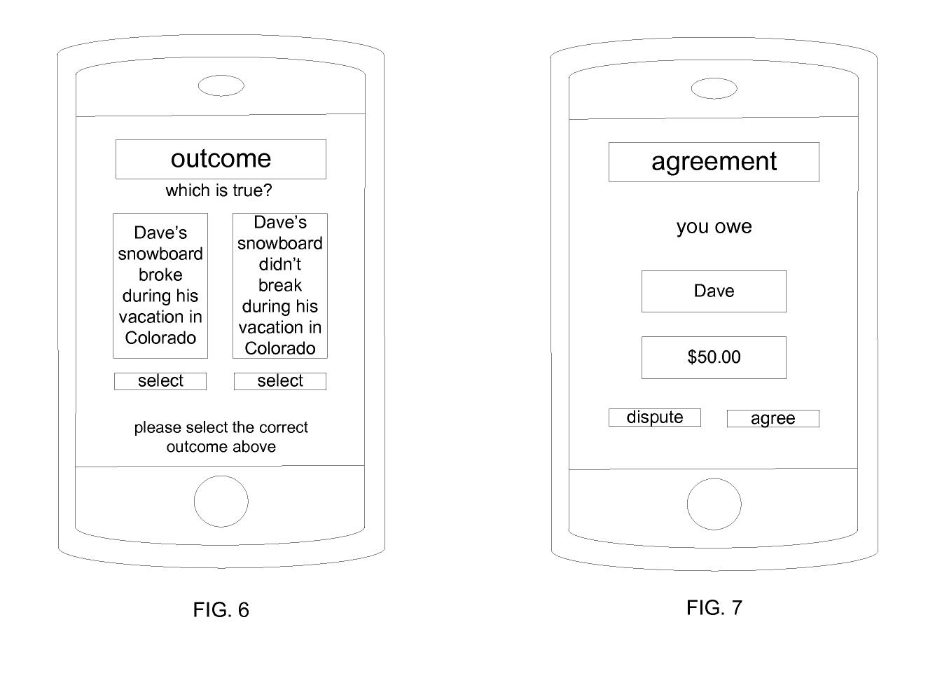

For instance, FIG. 6 shows a sample device executing agreement management software which, according to some non-limiting, exemplary embodiments, applies to the snowboard example above. In FIG. 6, the system requests input from Dave regarding the condition of that agreement, which was whether Dave's snowboard broke during the snowboarding trip. In this case, Dave may select outcome A, that the snowboard broke, or outcome B, that the snowboard did not break. Once the outcome is selected, then the system receives and processes the input submitted by the user (Dave, in this case).

Returning to FIG. 3, in step s34, the agreement management service reconciles the accounts of the user(s), according to the agreement and based upon the input received in step s33. According to some embodiments, the user or users who owe, under the terms of the agreement, are notified that they owe and/or are requested to pay, or the service deducts the appropriate account(s) by the appropriate amount. For instance, FIG. 7 shows a sample device executing agreement management software which, according to some non-limiting, exemplary embodiments, applies to the snowboard example above. In FIG. 7, the system notifies Steve that he owes Dave $50, because Dave's snowboard broke, and under the terms of their insurance agreement, if Dave's snowboard breaks, Steve will pay Dave $50.

In some embodiments, after a proposed agreement is accepted and before step s33, the maximum amount that each party might owe in any possible outcome is reserved, held in escrow, or charged to an account. Then, in step s34, accounts are reconciled by awarding any appropriate amount to the appropriate party or parties, and refunding amounts or removing charges as appropriate. For instance, in the snowboarding example above, at the time the agreement is made, Steve's account would be charged $50 and Dave's account would be charged $10 before Dave's snowboarding trip. If Dave's snowboard had broken during the snowboarding trip, then Dave would be awarded the $50 that is being held in escrow. Additionally, Dave would be refunded the $10 that he had submitted to be held in escrow, in case his snowboard had not broken during the trip. In some embodiments, instead of holding the amount in escrow, a credit card, PayPal account, bank account, or the like is pre-authorized for the amount or a temporary hold is placed for the amount. Then, in step s34, accounts are charged as appropriate, and any holds are removed as appropriate.

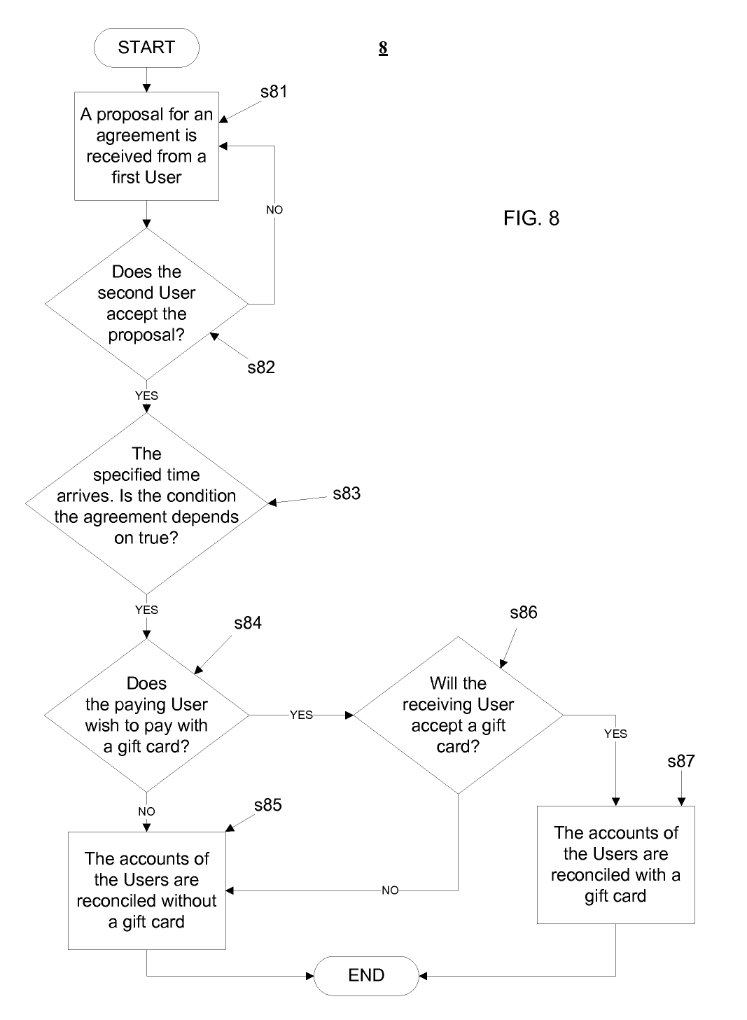

According to some embodiments, those who owe are requested to pay by the agreement management service suggesting that the one or more owing users make the payment by purchasing one or more offers in lieu of the payment. In some of those embodiments, the service suggests that the owing party (or parties) purchase one or more gift cards. An example of some of those embodiments is implemented by the computer system 8 according to a process as shown in FIG. 8. According to step s84, the system 8 offers that the owing user settle what is owed by purchasing a gift card. In some embodiments, the gift card is offered at a discount. According to some embodiments, multiple offers, such as for gift cards, are supplied by the service to the owing party (or parties) and the service receives input regarding whether one or more of these offers is accepted. In some embodiments, the discount varies between offers, or the discount is the same for some or all of the offers.

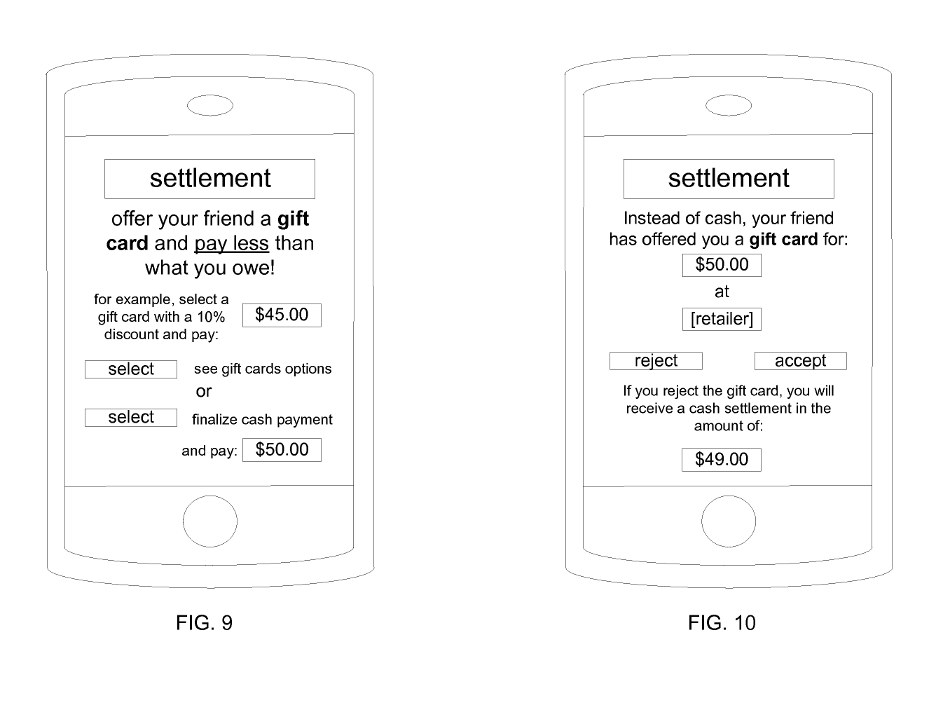

For instance, FIG. 9 shows a sample device executing agreement management software which, according to some non-limiting, exemplary embodiments, applies to the snowboard example above. In FIG. 9, the service offers to sell Steve a $50 gift card for $45 (a 10% discount), which would be used to settle Steve's debt of $50 to Dave.

Returning to FIG. 8, if the owing party or parties does not agree to buy the gift card or other offer, the accounts are reconciled as normal, in step s85 (as they would be in step s34 of FIG. 3). If the owing party or parties does agree to buy the gift card or other offer, then in step s86 of FIG. 8, the agreement management service asks the owed party or parties whether they are willing to accept the gift card or other offer as payment. If the owed party declines, then the account is reconciled as normal, in step s85. However, if the owed party agrees to accept the gift card or other offer in lieu of a normal payment, then in step s87, the account is reconciled with the gift card or other offer purchased by the owing party.

The owed party may have various incentives to accept an offer instead of payment. In some embodiments, if the owed party declines, then the system imposes a penalty on the owed party. For example, in further embodiments, the penalty includes a deduction from the payment amount. According to some alternative embodiments, there is no penalty. In such cases, the owed party may be a friend of the owing party and may wish to save the friend some money by agreeing to accept the gift card.

For instance, FIG. 10 shows a sample device executing agreement management software which, according to some non-limiting, exemplary embodiments, applies to the snowboard example above. In FIG. 10, the service informs Dave that Steve agreed to purchase a $50 gift card to be used at a specified retailer to settle the debt of $50. The service warns Dave that if the gift card is not accepted, then Dave will be penalized $1. That is, instead of receiving the full $50 from Steve, Dave will receive $49 of the $50 that Steve will pay.

According to some embodiments, gift cards or other settlement offers are provided in the form of a coupon or gift card, which is online and may be printed, viewable on a mobile device, or is in hardcopy form. In some embodiments, they are provided as a code that can be input into a computer system or verified by hand, or alternatively, an email is sent with appropriate instructions regarding how to redeem the offer, or as yet another alternative, a scannable code will be provided to the recipient so that the recipient's identity can be verified.

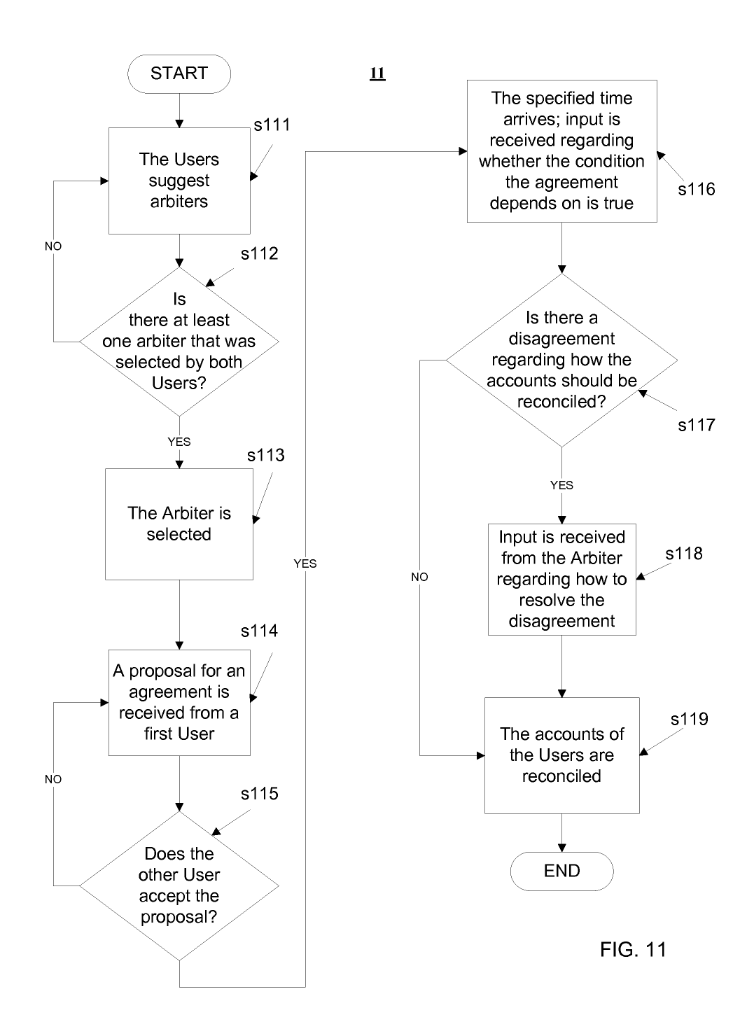

With reference to FIG. 11, according to various embodiments, the agreement management service is implemented by the computer system 11 according to a process as shown in FIG. 11. In step sill, before an agreement is proposed, the users suggest arbiters who will arbitrate a dispute should one arise. In system 11, this is done in preparation for a disagreement that may arise as a result of an agreement. In some embodiments, the service requests, before it is determined that there is a disagreement, that one or more users suggest at least one arbiter. For example, according to some of those embodiments, the service requests input on arbiters at the time the agreement is made, as in step s111. However, in some embodiments, the service requests, after it is determined that there is a disagreement, that one or more users submit at least one arbiter is suggested.

In some embodiments, the agreement management service requires that suggested arbiters be registered users of the service. In other embodiments, the service does not require that arbiters be registered users.

In step s112, the system 11 determines whether at least one arbiter was submitted by both (or all) users that will be. If not, then the system 11 repeats step sill, requesting that the users suggest arbiters. If there was only one arbiter that was submitted by each of the users, then the system 11 selects that user as the potential arbiter in step s113. In some embodiments, the agreement management service then notifies the arbiter that he or she has been selected as an arbiter. In further embodiments, the service requests input from the arbiter regarding whether he or she is willing to serve as the arbiter. If he or she is not willing, then according to some embodiments, the users repeat step sill and select a new arbiter.

In some embodiments, instead of picking the arbiter by selecting the only one that is chosen by both (or all) users, the agreement management service requests that two or more users rank the suggested arbiters. According to some non-limiting, exemplary embodiments, the service requests that the user(s) submits multiple arbiters and rank them from most preferred to least preferred. In further non-limiting, exemplary embodiments, the service assigns point values to the rankings For example, the top choice may be given three and a half points, the second choice two points, and the third choice one point.

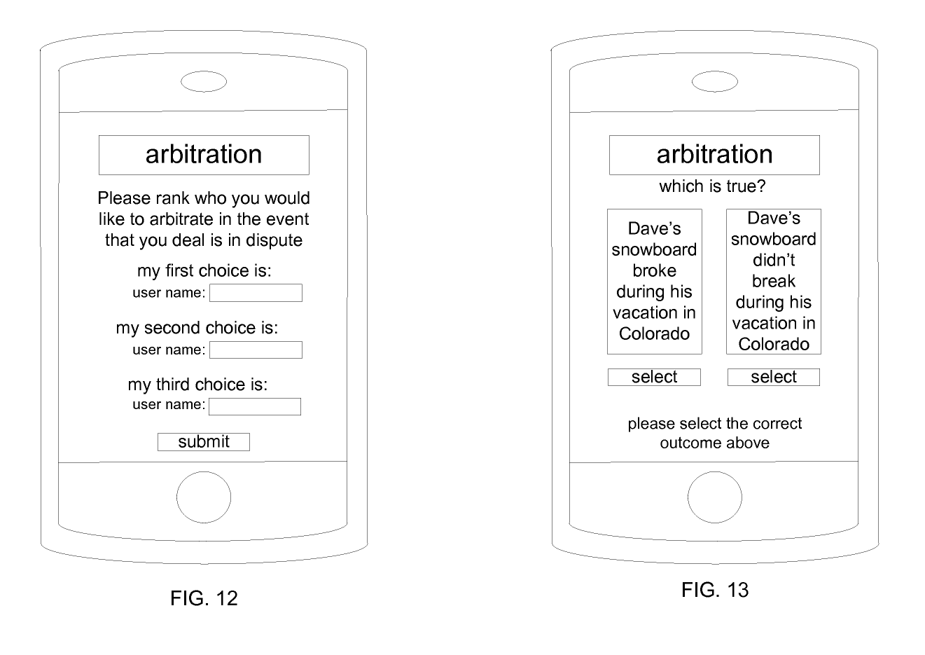

For instance, FIG. 12 shows a sample device executing agreement management software which, according to some non-limiting, exemplary embodiments, requests input from a user regarding arbiters. In FIG. 12, the service requests that the user submit the user names of three arbiters, in order of most preferred (labeled “first choice” in FIG. 12) to least preferred (labeled “third choice” in FIG. 12).

In some embodiments, once the ranks are received, the service selects the arbiter based at least in part on the ranking According to some non-limiting, exemplary embodiments, the suggested arbiter with the highest point total aggregated among all suggesting users will be the arbiter. In some embodiments, the ranking is only considered if there are multiple suggested arbiters that are suggested by more than one user. That is, if there are two users suggesting arbiters, at least two arbiters would have been suggested by both of the suggesting users for the ranking to have an effect in the arbiter selection process.

According to some embodiments, more than one arbiter is selected by the agreement management service to arbitrate a disagreement, should one arise.

In step s114, a proposal for an agreement is received from a user or group of users (see above discussion of step s31 of FIG. 3). In step s115, the system 11 determines whether the other user(s) accepts the proposal (see above discussion of step s32 of FIG. 3). In step s116, input is received from at least one user regarding whether the condition the agreement depends on is true (see above discussion of step s33 of FIG. 3).

There may be a disagreement between users regarding whether the condition is true at the time specified in the agreement. The system 11 determines this in step s117. According to some embodiments, step s117 involves the service accepting input from one or more users regarding whether they disagree with input previously submitted by a user. In some embodiments, step s117 involves the service automatically determining that there is a disagreement when it receives conflicting input from at least two users. If there is no disagreement, the accounts are reconciled as normal, in step s119 (as they would be in step s34 of FIG. 3).

If there is a disagreement, then in step s118, the system 11 begins an arbitration process. The system 11 requests input from the selected arbiter(s) to resolve the disagreement. In various embodiments, the input is related to whether the condition specified in the agreement is (or was) true at the time specified in the agreement. The system 11 then accept input from the selected arbiter(s). This input is used by the system 11 to resolve the dispute, by determining which user(s) (if any) owe, and what amount do they owe (if any).

For instance, FIG. 13 shows a sample device executing agreement management software which, according to some non-limiting, exemplary embodiments, requests input from an arbiter for the snowboard example above. Jane, the arbiter, is sent a request from the service, asking her to resolve the dispute between Dave and Steve. The service then accepts input from Jane regarding whether the snowboard broke during Dave's vacation. If Jane indicates that the snowboard broke, then the service will determine that Steve owe Dave $50. If Jane indicates that the snowboard did not break, then the service will determine that Dave owes Steve $10.

Returning to FIG. 11, in step s119, the system 11 reconciles the accounts of the user(s), according to the agreement and based upon the input received in step s118 in a similar manner to step s34 of FIG. 3. As in steps s84, s86, and s87 of FIG. 8, according to some embodiments, reconciling the account may include the system 11 suggesting that the one or more owing users make the payment by purchasing one or more offers (such as an offer for a gift card) in lieu of the payment.

Some embodiments of the present invention use just one processor of a computer system. Other embodiments use multiple processors. In some embodiments involving multiple processors, the processors are in the same computer. In other embodiments, the processors are in more than one computer.

Various modifications will be readily apparent to those with ordinary skill in the art and the generic principles herein may be applied to other embodiments. Software or hardware, for instance, could incorporate the features described herein and that embodiment would be within the spirit and scope of the present invention. Thus, the present invention is not intended to be limited to the embodiments shown, but is to be accorded the broadest scope consistent with the principles and features described herein.

The embodiments disclosed herein are to be considered in all respects as illustrative, and not restrictive of the invention. The present invention is in no way limited to the embodiments described above. Various modifications and changes may be made to the embodiments without departing from the spirit and scope of the invention. The scope of the invention is indicated by the attached claims, rather than the embodiments. Various modifications and changes that come within the meaning and range of equivalency of the claims are intended to be within the scope of the invention.

What is claimed is:

1. A process for managing a contractual agreement using a computer with a processor, the process comprising:
receiving, with the processor, a submission of information about an agreement from one or more submitting users;
wherein the agreement specifies that, if a particular condition is true at a specified time, a payment will be made from one or more paying users;
storing, with the processor, information about the agreement on non-transient storage media of the computer system; and
receiving, at the specified time, with the processor, input from one or more selected users that indicates whether the particular condition is true.

2. The process of claim 1, wherein the process is implemented by at least one device communicating directly with another device through a peer-to-peer network.

3. The process of claim 1, wherein the agreement further specifies that, if the particular condition is not true, an alternate payment will be made from one or more alternate paying users.

4. The process of claim 1, wherein the accepting a submission of an agreement comprises:
receiving, with the processor, from the one or more submitting users, a proposal for the agreement; and
receiving, with the processor, from one or more accepting users, an acceptance of the proposal for the agreement.

5. The process of claim 1, wherein the stored information about the agreement is stored in encrypted form.

6. The process of claim 1, further comprising:
requesting, with the processor, if input from the one or more selected users indicates that the particular condition is true, that the one or more paying users make the payment; and
suggesting, with the processor, that the one or more paying users make the payment by purchasing one or more offers in lieu of the payment.

7. The process of claim 6, further comprising:
offering, with the processor, if the one or more paying users agrees to purchase the one or more offers, a gift card to at least one receiving user in lieu of at least part of a payment due to the at least one receiving user.

8. The process of claim 1, further comprising:
receiving, with the processor, at least one suggested arbiter from at least one suggesting user;
receiving, with the processor, input from the at least one arbiter regarding whether the particular condition is true; and
deciding, with the processor, whether the one or more paying users should make the payment, based at least partially on the input from the at least one arbiter.

9. The process of claim 1, further comprising:
receiving, with the processor, at least one suggested arbiter from at least one suggesting user;
requesting, with the processor, that the at least one suggesting users suggest one or more different arbiters, if no at least one suggested arbiters was suggested by more than one of the at least one suggesting users;
receiving, with the processor, at least one newly suggested arbiter from at least one suggesting user, if no at least one suggested arbiters was suggested by more than one of the at least one suggesting users;
selecting, with the processor, one arbiter from the at least one suggested arbiter or the at least one newly suggested arbiter;
receiving, with the processor, input from the one arbiter regarding whether the particular condition is true; and
deciding, with the processor, whether the one or more paying users should make the payment, based at least partially on the input from the one arbiter.

10. The process of claim 8, further comprising:
receiving, with the processor, at least one suggested arbiter and a rank for each of the at least one suggested arbiter from at least one suggesting user;
selecting, with the processor, one arbiter from the at least one suggested arbiters;
wherein the arbiter is selected based at least in part on ranking received from the one or more users;
receiving, with the processor, input from the one arbiter regarding whether the particular condition is true; and
deciding, with the processor, whether the one or more paying users should make the payment, based at least partially on the input from the one arbiter.

11. A computer-implemented system for managing a contractual agreement, the system comprising:
a storage medium for storing information about an agreement; and
a processor configured to:
store, in the storage medium, a submission of information about the agreement from one or more submitting users;
wherein the agreement specifies that, if a particular condition is true at a specified time, a payment will be made from one or more paying users; and
store, in the storage medium, at the specified time, input from one or more selected users that indicates whether the particular condition is true occurred.

12. A system of claim 11, wherein the system is implemented by at least one device communicating directly with another device through a peer-to-peer network.

13. The system of claim 11, wherein the agreement further specifies that, if the particular condition is not true, a different payment will be made from one or more different paying users.

14. The system of claim 11, wherein the accepting a submission of an agreement includes that the processor is configured to:
store, in the storage medium, a proposal for the agreement from the one or more submitting users; and
store, in the storage medium, an acceptance of the proposal for the agreement from one or more accepting users.

15. The process of claim 1, wherein the stored information about the agreement is stored in encrypted form.

16. The system of claim 11, the processor further configured to:
request, if input from the one or more selected users indicates that the particular condition is true, that the one or more paying users make the payment; and
suggest that the one or more paying users make the payment by purchasing an offer in lieu of the payment.

17. The system of claim 16, the processor further configured to:
offer, if the one or more paying users agrees to purchase the one or more offers, a gift card to at least one receiving user in lieu of at least part of a payment due to the at least one receiving user.

18. The system of claim 11, the processor further configured to:
accept at least one suggested arbiter from at least one suggesting user;
store, in the storage medium, input from the at least one arbiter regarding whether the particular condition is true; and
decide whether the one or more paying users should make the payment, based at least partially on the input from the at least one arbiter.

19. The system of claim 18, the processor further configured to:
accept at least one suggested arbiter from at least one suggesting user;
request that the at least one suggesting users suggest one or more different arbiters, if none of the at least one suggested arbiter was suggested by more than one of the at least one suggesting user;
accept at least one newly suggested arbiter from at least one suggesting user, if none of the at least one suggested arbiter was suggested by more than one of the at least one suggesting user;
select one arbiter from the at least one suggested arbiter or the at least one newly suggested arbiter;
store, in the storage medium, input from the one arbiter regarding whether the particular condition is true; and
decide whether the one or more paying users should make the payment, based at least partially on the input from the one arbiter.

20. The system of claim 18, the processor further configured to:
accept at least one suggested arbiter and a rank of each of the at least one suggested arbiter from at least one suggesting user;
select one arbiter from the suggested arbiters;
wherein the one arbiter is selected based at least in part on the ranking received from the at least one suggesting user;
store, in the storage medium, input from the one arbiter regarding whether the specified particular is true; and
decide whether the one or more paying users should make the payment, based at least partially on the input from the one arbiter.
